(19) United States
(12) Patent Application Publication
(10) Pub. No.: US 2026/0152398 A1
(43) Pub. Date: Jun. 4, 2026

(54) METHOD FOR MANUFACTURING FIBER-TYPE ELECTRODE MATERIALS CONTAINING OXYGEN FUNCTIONAL GROUPS

(71) Applicant: KOREA INSTITUTE OF SCIENCE AND TECHNOLOGY, Seoul (KR)

(72) Inventors: Hyeonsu JEONG, Seoul (KR); Nam Dong KIM, Seoul (KR); Seung Min KIM, Seoul (KR); Hayoung YU, Seoul (KR)

(21) Appl. No.: 18/971,517

(22) Filed: Dec. 6, 2024

(30) Foreign Application Priority Data
Dec. 3, 2024 (KR) 10-2024-0177528

(51) Int. Cl. C01B 32/174

(52) U.S. Cl. CPC C01B 32/174; C01B 2202/22; C01B 2202/26; C01P 2002/01; C01P 2002/82; C01P 2002/85; C01P 2004/03; C01P 2006/40; C01P 2006/90

(57) ABSTRACT

The oxygen functional group-containing carbon nanotube fiber according to an exemplary embodiment of the present disclosure is a carbon nanotube fiber including a functionalized carbon nanotube including an oxygen functional group positioned on the surface of the carbon nanotube, wherein an oxygen content is 8.0 to 20.0 at %, and the oxygen functional group includes one or more selected from —O—C═O, —C—O, —C═O, —C═O—C, and a carboxyl group.

### CROSS-REFERENCE TO RELATED APPLICATION

This application claims priority to and the benefit of Korean Patent Application No. 10-2024-0177528 filed at the Korean Intellectual Property Office on Dec. 3, 2024, the entire contents of which are incorporated herein by reference.

### BACKGROUND OF THE DISCLOSURE

### (a) Field of the Disclosure

The following disclosure relates to an oxygen functional group-containing carbon nanotube fiber having high capacitance, high energy density, high electric power density, and high durability, and a method for producing the same.

### (b) Description of the Related Art

Though latest wearable devices are expected to show rapid demand and growth in various industrial fields, energy storage devices (such as battery) which operate the wearable devices still maintain a heavy and rigid form, and thus, the growth of the wearable devices is limited.

In order to solve the problem, atypical energy storage devices are actively developed, and among them, fiber-type energy electrode materials which are light and flexible are evaluated as the most ideal form of electrode, but conventional materials have the following problems.

Conventional metal wires have excellent conductivity, but since they are heavy and not flexible due to their high specific gravity, they do not satisfy wearable characteristics. In order to replace the conventional metal wires, (reduced) graphene fibers, carbon fibers, and the like which are nanocarbon-based fibers are being studied, but they have low conductivity in the kS/m range and poor flexibility due to a heat treatment process.

The carbon nanotube or graphene oxide has excellent mechanical, thermal, and electrical properties. A fibrous aggregate which exists in a continuous phase, not as an individual carbon nanotube or graphene oxide, that is, carbon nanotube or graphene oxide fibers may be produced in a fiber form as it is or in a fabric form and used in various ways. Since the oxygen functional group-containing carbon nanotube fibers have a low density up to a ⅕ of a metal such as copper and high electrical conductivity of up to 10 times that of conventional carbon fibers, it is light as in the ultra-light composite material field, has excellent conductivity, and is very effective in producing materials having high strength. However, since it has no electrochemical activity, it requires additional materials or treatment in order to apply it as an electrode.

In order to solve the problem, electrochemical activity may be imparted while deterioration of physical properties may be minimized, by using a method for coating the surface of carbon nanotube fibers with an active material having electrochemical activity. However, when the fiber is used for a long time or physically deformed (e.g., bends or knots), the active material is highly likely to be separated from the fiber. In addition, an additional process for an active material and complexation is needed to increase the cost.

Other than that, in order to increase energy storage efficiency without an active material, a study for increasing a specific surface area by adjusting a fiber porosity is in progress. However, in this case, the internal structure of fibers becomes loose, which rapidly weakens strength so that it is difficult to respond to various physical deformations and reduces securing durability against impact. In addition, electrical conductivity as well as mechanical strength is decreased, resulting in trade off.

Accordingly, a material produced with a new strategy, which may increase electrochemical activity without an additional active material and deterioration of basic physical properties, is needed.

### SUMMARY OF THE DISCLOSURE

The present disclosure attempts to provide an oxygen functional group-containing carbon nanotube fiber and a method for producing the same.

An exemplary embodiment of the present disclosure provides an oxygen functional group-containing carbon nanotube fiber including a functionalized carbon nanotube including an oxygen functional group positioned on a surface of a carbon nanotube, wherein an oxygen content is 8.0 to 20.0 at %.

The oxygen functional group may include one or more of —O—C═O, —C—O, —C═O, —C═O—C, and a carboxyl group.

The oxygen functional group-containing carbon nanotube fiber may have a specific tensile strength of 0.3 N/tex or more.

The oxygen functional group-containing carbon nanotube fiber may have a specific electrical conductivity of 1380 Sm²/kg or more.

The oxygen functional group-containing carbon nanotube fiber may have a capacitance (specific capacitance) of 100 F/g or more.

Another exemplary embodiment of the present disclosure provides a method for producing oxygen functional group-containing carbon nanotube fibers including: forming a spinning dope obtained by dispersing functionalized carbon nanotubes including an oxygen functional group positioned on a surface of a carbon nanotube in a solvent; and spinning the spinning dope to obtain oxygen functional group-containing carbon nanotube fibers, wherein the functionalized carbon nanotubes have an oxygen content of 8.0 to 20.0 at %.

The functionalized carbon nanotube may have a contact angle of 30.0° or less.

The functionalized carbon nanotubes may include a surface defect structure and include one or more surface defect structures per 10 nm of a carbon nanotube length.

The functionalized carbon nanotubes may be formed by adding a carbon nanotube raw material to an acid solution and then performing an acid treatment.

A water contact angle of the functionalized carbon nanotube (F-CNT) may be decreased by 60% or more as compared with the contact angle of the carbon nanotube (CNT) raw material.

In the forming of a spinning dope obtained by dispersing functionalized carbon nanotubes in a solvent, a concentration of the functionalized carbon nanotubes in the spinning dope may be 50 mg/mL or more.

Still another exemplary embodiment of the present disclosure provides an electrochemical device including the oxygen functional group-containing carbon nanotube fibers as an electrode.

The oxygen functional group-containing carbon nanotube fiber according to an exemplary embodiment of the present disclosure has effects of having improved capacitance, energy density, electric power density, and durability.

In an exemplary embodiment of the present disclosure, oxygen functional group-containing carbon nanotube fibers may be produced without using an additional active material.

### BRIEF DESCRIPTION OF THE DRAWINGS

FIG. 1 schematically shows a process of producing carbon nanotube fibers according to an exemplary embodiment of the present disclosure.

FIG. 2 shows TEM analysis images of a raw material carbon nanotube (CNT) and a functionalized carbon nanotube (F-CNT).

FIG. 3 shows SEM images of the surface and the cross section of oxygen functional group-containing carbon nanotube fibers (F-CNTF) produced according to Example 1 and Comparative Example 1.

FIG. 4 shows contact angle analysis results of a raw material carbon nanotube (CNT) and a functionalized carbon nanotube (F-CNT).

FIG. 5A and FIG. 5B show POM analysis results of a carbon nanotube (CNT) spinning dope and a functionalized carbon nanotube (F-CNT) spinning dope.

FIG. 6A and FIG. 6B show XPS analysis results of raw material CNT and functionalized CNT.

FIG. 7A and FIG. 7B show Raman analysis results of the oxygen functional group-containing carbon nanotube fibers produced according to Example 1 and Comparative Example 1.

FIG. 8A and FIG. 8B show polarized Raman analysis results of the oxygen functional group-containing carbon nanotube fibers produced according to Example 1 and Comparative Example 1.

FIG. 9 shows results of measuring specific tensile strength and tensile modulus of the oxygen functional group-containing carbon nanotube fibers produced according to Example 1 and Comparative Example 1.

FIG. 10 shows results of analyzing electrical conductivity, specific electrical conductivity, tensile strength, and specific tensile strength of the oxygen functional group-containing carbon nanotube fibers produced according to Example 1 and Comparative Example 1.

FIG. 11 shows a CV graph in a 3-electrode electrochemical activity test.

FIG. 12 shows results of analyzing specific capacitance and volume capacitance of an electrode to which the oxygen functional group-containing carbon nanotube fibers according to Comparative Example 1 and Example 1 depending on current density.

FIG. 13 shows results of a cycle performance test depending on the number of bends of a fiber-type supercapacitor to which the oxygen functional group-containing carbon nanotube fibers according to Example 1 were applied.

FIG. 14 shows results of a capacity value change test by knotting a fiber-type supercapacitor.

FIG. 15 shows photographs of a demonstration example of applying a supercapacitor to which the oxygen functional group-containing carbon nanotube fibers according to Example 1 were applied.

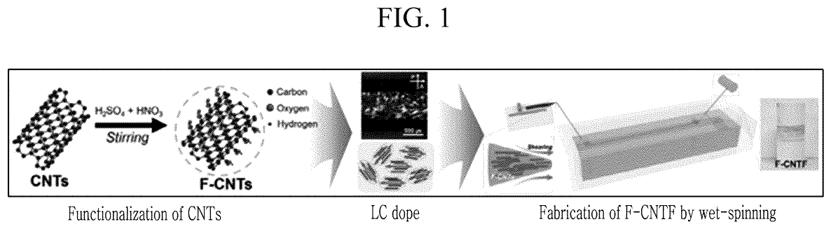

### DETAILED DESCRIPTION OF THE EMBODIMENTS

The terms such as first, second, and third are used for describing various parts, components, areas, layers, and/or sections, but are not limited thereto. These terms are used only for distinguishing one part, component, area, layer, or section from other parts, components, areas, layers, or sections. Therefore, a first part, component, area, layer, or section described below may be mentioned as a second part, component, area, layer, or section without departing from the scope of the present disclosure.

The terminology used herein is only for mentioning a certain example and is not intended to limit the present disclosure. Singular forms used herein also include plural forms unless otherwise stated clearly to the contrary. The meaning of “comprising” used in the specification is embodying certain characteristics, areas, integers, steps, operations, elements, and/or components, but is not excluding the presence or addition of other characteristics, areas, integers, steps, operations, elements, and/or components.

When it is mentioned that a part is “on” or “above” the other part, it means that the part is directly on or above the other part or another part may be interposed therebetween. In contrast, when it is mentioned that a part is “directly on” the other part, it means that nothing is interposed therebetween.

Though not defined otherwise, all terms including technical terms and scientific terms used herein have the same meaning as commonly understood by a person with ordinary skill in the art to which the present disclosure pertains. Terms defined in commonly used dictionaries are further interpreted as having a meaning consistent with the related technical literatures and the currently disclosed description, and unless otherwise defined, they are not interpreted as having an ideal or very formal meaning.

In the present specification, the term “combination(s) thereof” described in the Markush format refers to a mixture or combination of one or more selected from the group consisting of the constituent elements described in the Markush format and refers to inclusion of one or more selected from the group consisting of the constituent elements.

Hereinafter, an exemplary embodiment of the present disclosure will be described in detail so that a person with ordinary skill in the art to which the present disclosure pertains may easily carry out the present disclosure. As those skilled in the art would realize, the described embodiments may be modified in various different ways, all without departing from the spirit or scope of the present disclosure.

### 1. Functionalized Carbon Nanotube (F-CNT)

The present disclosure provides a functionalized carbon nanotube (F-CNT).

Hereinafter, in the description of the specification, the functionalized carbon nanotube (F-CNT) may also be referred to as a functionalized carbon nanotube or F-CNT, and these are the same materials.

The functionalized carbon nanotube (F-CNT) according to an exemplary embodiment of the present disclosure may include an oxygen functional group positioned on the surface of the carbon nanotube (CNT).

An oxygen content in the functionalized carbon nanotubes (F-CNT) may be 3.0 at % or more, specifically 3.0 to 20.0 at %, 8.0 to 20.0 at %, or 10.0 to 20.0 at %.

The oxygen content in the present disclosure refers to a ratio of an oxygen atom to the total number of atoms on the surface.

In the present disclosure, the oxygen functional group may include one or more selected from —O—C═O, —C—O, —C═O, —C═O—C, and a carboxyl group.

When the oxygen content in the oxygen functional group-containing carbon nanotube fibers (F-CNTF) satisfies the range, compatibility with an electrolyte in a chemical device to which the carbon nanotube is applied is improved to improve electrochemical performance. When the oxygen content exceeds the range, electronic conductivity due to increased bonding is decreased to deteriorate electrochemical performance.

The functionalized carbon nanotube (F-CNTF) may include a surface defect structure formed on the surface of a carbon nanotube (CNT) and include one or more surface defect structures, specifically 1 to 10, 2 to 10, or 2 to 7 surface defect structures per 10 nm of a carbon nanotube (CNT) length.

In the present disclosure, the surface defect structure may be confirmed from a transmission electron microscope (TEM) analysis image.

The surface defect structure included in the functionalized carbon nanotube (F-CNT) in the present disclosure is caused by an oxygen functional group, and electrochemical performance is improved by including the surface defect structure.

The functionalized carbon nanotube (F-CNT) may have a contact angle of 30.0° or less, specifically 30.0° or less, or 5.0 to 6.0°. When a water contact angle of the functionalized carbon nanotube (F-CNT) satisfies the range, a contact area with an electrolyte of an electrochemical device is increased due to excellent hydrophilicity, which improves ion conductivity to improve electrochemical performance of a chemical device to which the functionalized carbon nanotubes are applied.

In a Raman spectrum obtained by Raman analysis of the functionalized carbon nanotube (F-CNT), an intensity ratio (IG-FCNT/ID-FCNT) between an intensity (IG-FCNT) near a G peak (around 1580 cm⁻¹) and an intensity (ID-FCNT) near a D peak (around 1350 cm⁻¹) may be 18.5 to 21.0.

In the present disclosure, when the Raman peak intensity ratio (IG-FCNT/ID-FCNT) of the functionalized carbon nanotube (F-CNT) satisfies the range, a defective structure is appropriately introduced while an aligned sp² carbon structure of the carbon nanotube (CNT) is maintained, thereby implementing excellent electrical conductivity, which is thus preferred.

When the Raman peak intensity ratio (IG-FCNT/ID-FCNT) of the functionalized carbon nanotube (F-CNT) is below the range, electrical conductivity and structural stability may be deteriorated, and when the Raman peak intensity ratio (IG-FCNT/ID-FCNT) exceeds the range, electrochemical activity may be deteriorated. Since the capacitance (specific capacitance) of the oxygen functional group-containing carbon nanotube fiber is 100 F/g or more, high capacitance may be implemented.

### 2. Method for Producing Functionalized Carbon Nanotube (F-CNT)

The present disclosure provides a method for producing functionalized carbon nanotubes (F-CNT).

In the method for producing functionalized carbon nanotubes (F-CNT) in the present disclosure, an acid treatment may be carried out after adding a carbon nanotube (CNT) raw material to an acid solution.

The carbon nanotube (CNT) raw material may be carbon nanotubes (CNT) having an average length of 5 μm or more and an average diameter of 1.0 to 3.0 nm and may have a metal impurity content of less than 10 wt %.

In the present disclosure, the acid solution may include one or more selected from sulfuric acid (H₂SO₄), nitric acid (HNO₃), hydrochloric acid (HCl), hydrogen peroxide (H₂O₂), potassium permanganate (KMnO₄), and specifically, may be a mixed acid of sulfuric acid (H₂SO₄) and nitric acid (HNO₃).

A mole ratio (H₂SO₄:HNO₃) between sulfuric acid (H₂SO₄) and nitric acid (HNO₃) may be in a range of 1:2.5 to 1:3.5.

The carbon nanotubes may be functionalized while minimizing damage to them, by mixing sulfuric acid (H₂SO₄) and nitric acid (HNO₃) in the above range. In addition, the content of an oxygen functional group introduced to the surface of the carbon nanotube (CNT) raw material may be appropriately adjusted, and the surface defect structure in an appropriate range is formed on the surface of carbon nanotube (CNT), resulting in improvement of electrochemical performance.

In addition, since metal impurities remaining in the carbon nanotube (CNT) raw material may be effectively improved, the oxygen functional group may be efficiently introduced.

After the carbon nanotube (CNT) raw material is added to the mixed acid, an oxidation reaction may be performed for 10 hours or more, specifically 20 hours or more or 20 to 30 hours with stirring at room temperature.

The oxygen functional group may be introduced to the surface of the carbon nanotube (CNT) by the oxidation reaction.

After completing the oxidation reaction, a solid content separated by solid-liquid separation may be washed using distilled water. The washing may be performed so that the pH of the separated solid content is 6.8 to 7.2, specifically 7.0.

A removal rate of an acid treatment residue on the surface of the carbon nanotube (CNT) may be improved and the purity of a final product may be improved, by washing to reach the pH.

The washed carbon nanotubes (CNT) may be dried at a temperature of 50 to 100° C. to produce functionalized carbon nanotubes (F-CNT).

The drying may be performed under vacuum conditions. Water remaining in the carbon nanotubes (CNT) may be effectively removed by drying under vacuum conditions, and an additional oxidation reaction may be prevented in the drying process.

The water contact angle of the functionalized carbon nanotube (F-CNT) in the present disclosure may be decreased by 60% or more, specifically 70% or more or 90% or more as compared with the water contact angle of the carbon nanotube (CNT) raw material. Thus, hydrophilicity of the functionalized carbon nanotube is greatly increased to strengthen an interaction with an electrolyte and improve ion conductivity and electrochemical performance.

In the present disclosure, an intensity ratio (I_{POCO_FCNT}/I_{POCO_CNT}) of a maximum peak intensity (I_{POCO_CNT}) between 288 and 291 eV in an XPS analysis graph of the functionalized carbon nanotube (F-CNT) to a maximum peak intensity (I_{POCO_FCNT}) between 288 and 291 eV in an XPS analysis graph of the carbon nanotube (CNT) raw material may be 2.0 to 3.0, specifically 2.5 to 3.0.

In the present disclosure, by adjusting the intensity ratio (I_{POCO_FCNT}/I_{POCO_CNT}) of the maximum peak intensity (I_{POCO_FCNT}) between 288 and 291 eV in the XPS analysis graphs of the carbon nanotube (CNT) raw material and the functionalized carbon nanotube (F-CNT), appropriate oxidation is performed in the mixed acid treatment process, so that an activation effect on the surface may be improved while preventing damage to the carbon nanotube structure.

Since the functionalized carbon nanotubes produced according to the method for producing functionalized carbon nanotubes are described in detail above, detailed description will be omitted herein.

### 3. Oxygen Functional Group-Containing Carbon Nanotube Fiber (F-CNTF)

The present disclosure provides an oxygen functional group-containing carbon nanotube fiber (F-CNTF).

The oxygen functional group-containing carbon nanotube fiber (F-CNTF) according to an exemplary embodiment of the present disclosure includes the functionalized carbon nanotube (F-CNT) described above.

The oxygen functional group-containing carbon nanotube fiber (F-CNTF) in the present disclosure includes the carbon nanotube on which an oxygen functional group is formed, thereby maximizing a contact area with an electrolyte and improving ion conductivity and reaction efficiency to implement electrochemical performance excellently.

Since the functionalized carbon nanotube (F-CNT) included in the oxygen functional group-containing carbon nanotube fiber (F-CNTF) is described in detail above, the detailed description will be omitted.

An IG∥/IG⊥ value measured in a polarized Raman spectroscopic spectrum of the oxygen functional group-containing carbon nanotube fiber (F-CNTF) may be 100 or more, specifically 100 to 150.

The IG∥/IG⊥ value in the polarized Raman analysis is an indicator showing an alignment degree of carbon nanotubes (CNT) and molecules in the fibers. By having the IG∥/IG⊥ value in the above range in the present disclosure, an electron migration path is efficiently formed in an axis direction to improve electrical conductivity.

The specific tensile strength of the oxygen functional group-containing carbon nanotube fiber (F-CNTF) may be 0.3 N/tex or more, specifically 0.5 N/tex or more or 0.6 to 1.0 N/tex.

The oxygen functional group-containing carbon nanotube fiber (F-CNTF) may have a tensile strength of 0.8 GPa or more, specifically 0.8 to 1.0 GPa.

In the present disclosure, the oxygen functional group-containing carbon nanotube fiber (F-CNTF) satisfies the specific tensile strength and/or tensile strength, thereby implementing performance excellent in all of high strength, light weight, and durability.

The oxygen functional group-containing carbon nanotube fiber (F-CNTF) may have a specific electrical conductivity of 1350 MS/m or more, specifically 1380 MS/m.

The oxygen functional group-containing carbon nanotube fiber (F-CNTF) may have an electrical conductivity of 1.5 MS/m or more, specifically 1.7 to 2.0 MS/m.

In the present disclosure, the oxygen functional group-containing carbon nanotube fiber (F-CNTF) satisfies the specific electrical conductivity and/or electrical conductivity, thereby implementing performance excellent in light weight and conductivity.

The oxygen functional group-containing carbon nanotube fiber (F-CNTF) may have a specific modulus of 90 N/tex or more, specifically 90 to 120 N/tex or 95 to 105 N/tex.

In the present disclosure, the oxygen functional group-containing carbon nanotube fiber (F-CNTF) satisfies the specific modulus, thereby implementing performance excellent in all of high strength, light weight, and durability.

The oxygen functional group-containing carbon nanotube fiber (F-CNTF) may have a specific tensile stress of 0.5 N/tex or more, specifically 0.6 to 0.8 N/tex.

In the present disclosure, the oxygen functional group-containing carbon nanotube fiber (F-CNTF) satisfies the specific tensile stress, thereby implementing performance excellent in all of high strength, light weight, and durability.

### 4. Method for Producing Oxygen Functional Group-Containing Carbon Nanotube Fibers (F-CNTF)

The present disclosure provides a method for producing oxygen functional group-containing carbon nanotube fibers (F-CNTF).

The method for producing oxygen functional group-containing carbon nanotube fibers (F-CNTF) according to the present disclosure may include: forming a spinning dope obtained by dispersing functionalized carbon nanotubes in a solvent; and spinning the spinning dope to obtain oxygen functional group-containing carbon nanotube fibers (F-CNTF).

Since the functionalized carbon nanotube (F-CNT) is described in detail above, detailed description will be omitted herein.

First, a step of forming a spinning dope obtained by dispersing functionalized carbon nanotubes (F-CNT) in a solvent is performed.

The solvent is not particularly limited as long as it may uniformly disperse the functionalized carbon nanotubes (F-CNT). For example, it may be a superacid solvent, and specifically, one or more selected from chlorosulfonic acid (CSA), sulfuric acid, fumed sulfuric acid (oleum), fluorosulfonic acid, trifluoroacetic acid, trifluoromethanesulfonic acid, fluoroantimonic acid, or carborane acid.

A concentration of the functionalized carbon nanotubes (F-CNT) in the spinning dope may be 50 mg/mL or more, specifically 50 to 160 mg/Ml or 110 to 160 mg/mL.

In the present disclosure, when the concentration of the functionalized carbon nanotubes (F-CNT) in the spinning dope satisfies the range, carbon nanotube fibers having improved mechanical strength, electrical conductivity, thermal conductivity, and density may be produced, which is thus preferred.

In particular, when a functionalized carbon nanotube (F-CNT) dope concentration is more than 160 mg/mL, it is confirmed that viscosity is excessively increased, so that spinning is not allowed.

In addition, when the concentration of functionalized carbon nanotubes (F-CNT) in the spinning dope satisfies the range, the functionalized carbon nanotube (F-CNT) in the spinning dope may show a lyotropic nematic phase. Since the lyotropic nematic phase is expressed as such, orientation, convergence, and the like of finally produced fibers may be improved to improve characteristics such as specific strength and specific elasticity.

The step of spinning the spinning dope to obtain oxygen functional group-containing carbon nanotube fibers may be performed by a method of wet spinning, liquid crystal spinning, or the like, and specifically, may be performed by the liquid crystal spinning.

In an exemplary embodiment of the present disclosure, the step of spinning the spinning dope to obtain oxygen functional group-containing carbon nanotube fibers (F-CNTF) may include: spinning the spinning dope to obtain an oxygen functional group-containing carbon nanotube fiber intermediate; stretching the oxygen functional group-containing carbon nanotube fiber intermediate; and drying the stretched oxygen functional group-containing carbon nanotube fiber intermediate.

In the present specification, a state of the oxygen functional group-containing carbon nanotube fibers before being completely dried may be expressed as an “intermediate”.

In the step of stretching the oxygen functional group-containing carbon nanotube fiber intermediate, the intermediate may be wound onto a bobbin at a constant speed using a winder, and the speed at which the intermediate is wound onto the bobbin may be more than 4 m/min, specifically 5 to 10 m/min. When the intermediate is wound onto the bobbin at the speed, oxygen functional group-containing carbon nanotube fibers having excellent physical properties, mechanical properties, and electrochemical properties may be produced, which is thus preferred.

The step of drying the stretched oxygen functional group-containing carbon nanotube fiber intermediate may be performed by placing the stretched intermediate in a vacuum oven and drying the intermediate while maintaining a temperature at 100° C. or higher to obtain the oxygen functional group-containing carbon nanotube fibers (F-CNTF). The drying temperature may be 100 to 200° C., specifically 130 to 160° C.

At this time, the stretched oxygen functional group-containing carbon nanotube fiber intermediate may be cleaned and dried. In the cleaning step, a solvent such as acetone and water may be used.

An exemplary embodiment of the present disclosure may provide an electrochemical device or an electrochemical device using the oxygen functional group-containing carbon nanotube fibers (F-CNTF) as an electrode.

The electrochemical device or electrochemical apparatus may be a lithium secondary battery, a supercapacitor, a fuel battery, an electrolysis device, a redox flow battery, or a solar battery, and may be produced using a common method known in the art, and its shape is not particularly limited.

The following examples illustrate the present disclosure in more detail. However, the following examples are only a preferred example of the present disclosure, but the present disclosure is not limited to the following examples.

### Preparation Example 1: Production of Functionalized Carbon Nanotube (F-CNT)

### (Preparation of Mixed Acid)

Sulfuric acid (H₂SO₄, 98%, Daejung Chemicals.) and nitric acid (HNO₃, 65%, Daejung Chemicals.) were added to a reaction vessel at a weight ratio of 3:1, and mixed to produce a mixed acid.

### (Acid Treatment)

Carbon nanotube (CNT) (length>5 μm, diameter: 1.6±0.4 nm, metal impurity<1 wt %, TUBALL, OC SiAl) powder was added to the mixed acid in the reaction vessel, and stirring was performed at a stirring speed of 500 rpm at room temperature for 24 hours to produce an acid-treated CNT.

At this time, 0.004 g of carbon nanotubes were added thereto per 1 mL of the mixed acid.

### (Washing)

The acid-treated CNT was separated using a filter, and the acid-treated CNT was washed using distilled water.

At this time, washing was repeated until the pH of filtered distilled water after the washing was 7.

### (Drying)

The washed CNT was separated, added to a vacuum oven, and dried at a temperature of 80° C. to obtain functionalized carbon nanotubes (F-CNT).

### Preparation Example 2: Production of CNT Spinning Dope

Carbon nanotube (CNT) (length>5 μm, diameter: 1.6±0.4 nm, metal impurity<1 wt %, TUBALL, OC SiAl) powder was dispersed in chlorosulfonic acid (CSA) to produce CNT spinning dopes by concentration.

### Preparation Example 3: Production of F-CNT Spinning Dope

The functionalized carbon nanotubes (F-CNT) produced according to Preparation Example 1 were dispersed in chlorosulfonic acid (CSA) to produce F-CNT spinning dopes by concentration.

The measured aspect ratio (L/d) of the carbon nanotube was calculated by an equation of φ_{c}=3.34(L/d)⁻¹φ_{c}, according to an Onsager theory. The carbon nanotubes were dispersed in chlorosulfonic acid at a specific concentration to confirm the concentration at which an Isotropic cloud point (φ_{c}) was shown by a polarizing microscope.

### Example 1

The functionalized carbon nanotubes (F-CNT) produced according to Preparation Example 1 were dispersed in chlorosulfonic acid (CSA) at a concentration of 160 mg/mL, and the dispersion was performed for 20 hours or more to produce a spinning dope.

The spinning dope produced above was coagulated in an acetone coagulation solution at a speed of 0.1 mL/min using a spinning device, wound onto a bobbin at a speed of 6 m/min, and dried in a vacuum oven at about 150° C. for 12 hours or more to finally produce oxygen functional group-containing carbon nanotube fibers (F-CNTF).

### Comparative Example 1

Carbon nanotube (CNT) (length>5 μm, diameter 1.6±0.4 nm, metal impurity<1 wt %, TUBALL, OC SiAl) powder was dispersed in chlorosulfonic acid (CSA) at a concentration of 30 mg/mL and dispersed for 20 hours or more to produce a spinning dope.

The spinning dope produced above was coagulated in an acetone coagulation solution at a speed of 0.1 mL/min using a spinning device, wound onto a bobbin at a speed of 4 m/min, and dried in a vacuum oven at about 150° C. for 12 hours or more to finally produce oxygen functional group-containing carbon nanotube fibers (CNTF).

### Evaluation Example 1: TEM Image Analysis

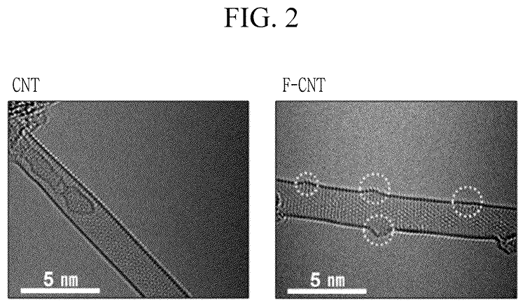

A carbon nanotube (CNT) as a raw material and a functionalized carbon nanotube (F-CNT) were measured by a transmission electron microscope (TEM) and the results are shown in FIG. 2.

Referring to FIG. 2, it was confirmed that the carbon nanotube (CNT) as a raw material had a smooth surface shape, while F-CNT had a defective structure formed on the surface of the wall.

### Evaluation Example 2: SEM Image Analysis

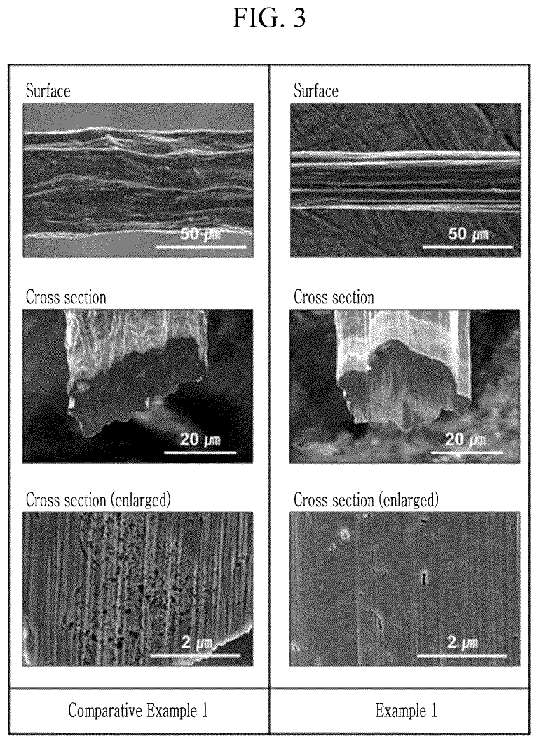

The results of SEM analysis of the surface and the cross section of the carbon nanotube fibers produced according to Example 1 and Comparative Example 1 are shown in FIG. 3.

Referring to FIG. 3, the surface of the oxygen functional group-containing carbon nanotube fiber (F-CNTF) produced according to Example 1 showed a smoother and more uniform shape than the surface of the carbon nanotube fiber (CNTF) produced according to Comparative Example 1. This is considered to be due to the improvement of dispersibility and alignment of the spinning dope using F-CNT.

Referring to FIG. 3, the cross section of the oxygen functional group-containing carbon nanotube fiber (F-CNTF) produced according to Example 1 had less pores and was formed to be denser than the carbon nanotube fiber (CNTF) produced according to Comparative Example 1. It is considered that F-CNT had greatly improved dispersibility and binding force due to oxidation functionality to improve the structural uniformity of finally produced fibers.

### Evaluation Example 3: Contact Angle Analysis

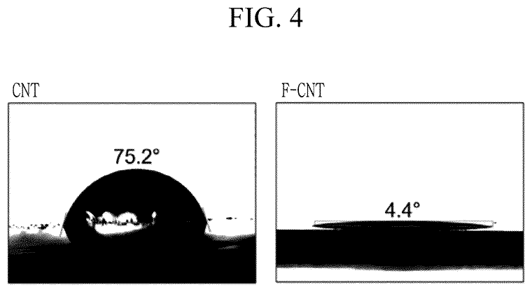

The contact angles of the carbon nanotube (CNT) as a raw material and the functionalized carbon nanotube (F-CNT) were measured using a contact angle analyzer (Phoenix 300 Touch Automatic Contact Angle Analyzer, SEO), and the analysis results are shown in FIG. 4.

Referring to FIG. 4, the contact angle of CNT as a raw material was 75.2° and the contact angle of F-CNT was 4.4°, which shows that the contact angle of the functionalized F-CNT was decreased by 94.1% as compared with the contact angle of CNT as a raw material.

### Evaluation Example 4: POM Analysis

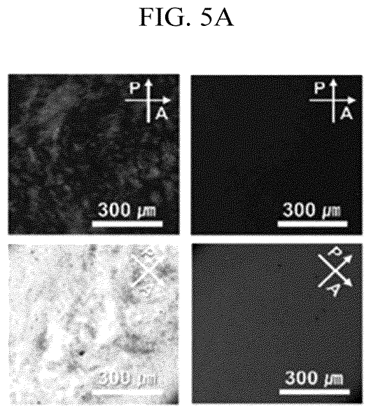

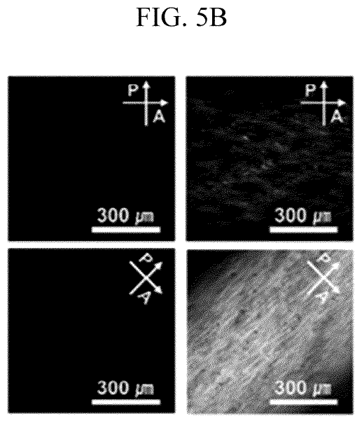

Results of observing phase transition properties depending on the concentration changes of the CNT spinning dope according to Preparation Example 2 and the F-CNT spinning dope according to Preparation Example 3 by a polarization optical microscope (POM) are shown in FIG. 5A and FIG. 5B.

FIG. 5A shows the case in which the concentration of CNT or F-CNT in the spinning dope was 2 mg/mL, and FIG. 5B shows the case in which the concentration of CNT or F-CNT in the spinning dope was 50 mg/mL.

Referring to FIG. 5A, when the concentration was 2 mg/mL, a Schlieren texture was observed in the CNT dope to show that a nematic phase was formed well. However, in the case of F-CNT, it was confirmed that the phase was not completely formed to maintain a biphase. It was because F-CNT became shorter due to the functionalization to increase a concentration required for a liquid crystal phase.

Referring to FIG. 5B, at a concentration of 50 mg/mL, the Schlieren texture disappeared from the CNT dope and black texture appeared, and the block texture appeared also when the cell was rotated at an angle of 45°. This was because bundling between CNTs occurred due to the high concentration so that polarized light did not pass through the cell, which means being out of the liquid crystal phase. However, in the case of F-CNT, birefringence was still observed at the same concentration, and since the liquid crystal was maintained well, this means a spinnable viscosity. That is, in the case of CNT, viscosity is increased at a high temperature to make spinning impossible, but in the case of F-CNT, concentration was increased to allow spinning.

### Evaluation Example 5: XPS Analysis

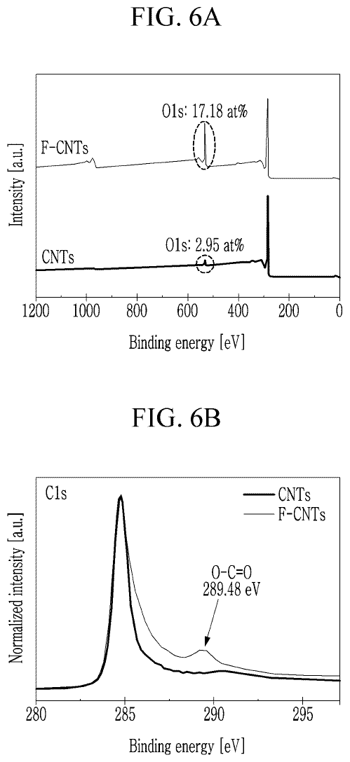

XPS analysis of CNT as a raw material and the functionalized carbon nanotube (F-CNT) produced according to Preparation Example 1 was carried out, and the results are shown in FIG. 6A and FIG. 6B.

Referring to FIG. 6A, it was confirmed that an oxygen (O) element ratio of CNT as a raw material was 2.95 at %, and an oxygen (O) element ratio of F-CNT was 17.18 at %.

Referring to FIG. 6B, it was confirmed that the O—C═O peak of F-CNT as compared with CNT as a raw material was greatly increased. Thus, the type of oxygen functional group introduced was confirmed therefrom.

### Evaluation Example 6: Raman Analysis

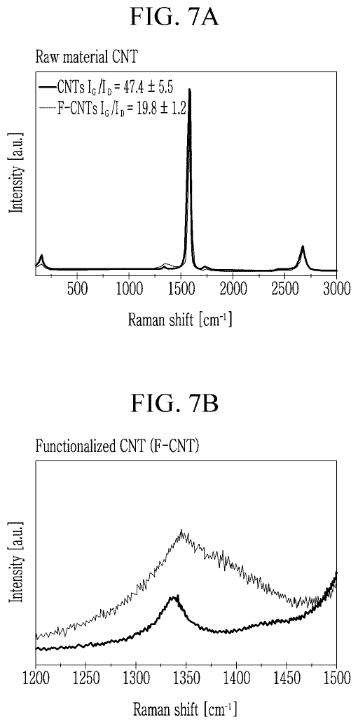

Raman analyses of the raw material carbon nanotube (CNT) and the functionalized carbon nanotube (F-CNT) produced according to Preparation Example 1 were carried out, and the analysis results are shown in FIG. 7A and FIG. 7B.

Specifically, analysis was performed 5 times for each of CNT and F-CNT and the results are shown in the following Table 1.

TABLE 1

| | | Average |
|---|---|---|
| | I_{G}/I_{D} | I_{G}/I_{D} |
| CNTs | 49.03806 | 47.4 |
| | 54.6383 | |
| | 39.77003 | |
| | 51.0255 | |
| | 42.33853 | |
| F-CNTs | 19.89183 | 19.8 |
| | 18.32982 | |
| | 21.85754 | |
| | 20.33587 | |
| | 18.83192 | |

Referring to FIG. 7A, FIG. 7B and Table 1, it was shown that an intensity ratio (I_{G-CNT}/I_{D-CNT}) between an intensity (I_{G-CNT}) at a G peak (near 1580 cm⁻¹) and an intensity (I_{D-CNT}) of a D peak (near 1350 cm⁻¹) in the Raman spectrum of CNT as a raw material was about 47.4, and the value of F-CNT (IG-FCNT/ID-FCNT) was about 19.8. This means that crystallinity was decreased by functionalization.

### Evaluation 7: Polarized Raman Analysis

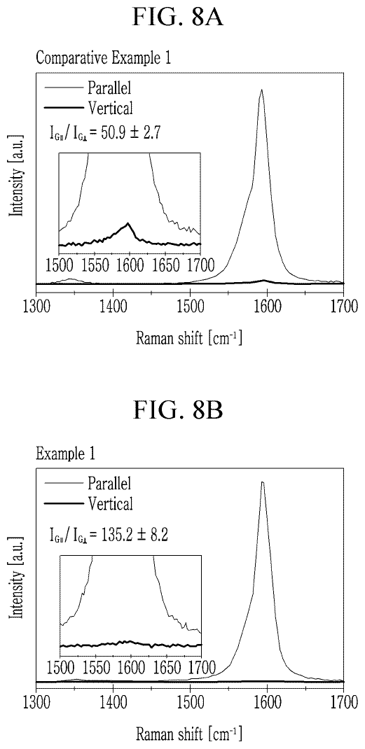

Polarized Raman analyses of the oxygen functional group-containing carbon nanotube fibers (F-CNTF) produced according to Example 1 and Comparative Example 1 were carried out, and the results are shown in FIG. 8A and FIG. 8B.

Referring to FIG. 8A and FIG. 8B, it was shown that an IG∥/IG⊥ value which is a ratio of parallel and vertical intensities of the oxygen functional group-containing carbon nanotube fiber (F-CNTF) produced according to Example 1 was 135.2 8.2, and an IG∥/IG⊥ value of the oxygen functional group-containing carbon nanotube fiber (F-CNTF) produced according to Comparative Example 1 was 50.9±2.7.

In example 1, it is considered to be due to the fact that F-CNT maintained a crystal liquid phase at a high concentration by oxidation functionalization to maintain an appropriate viscosity, which maximized a shear-induced alignment effect when passing through a spinning sozzle to improve the alignment degree of fiber.

### Evaluation 8: Tensile Modulus Analysis

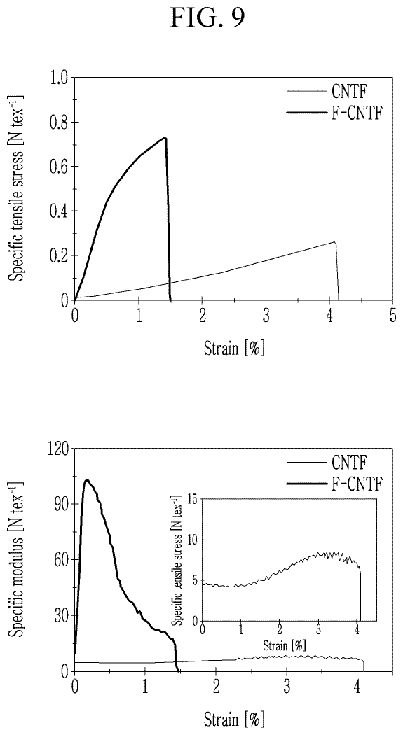

Specific tensile strength and tensile modulus of the oxygen functional group-containing carbon nanotube fibers (F-CNTF) produced according to Example 1 and Comparative Example 1 were measured, using FAVIMAT+ (short fiber physical property measuring instrument), and are shown in FIG. 9.

Referring to FIG. 9, the oxygen functional group-containing carbon nanotube fiber (F-CNTF) produced according to Comparative Example 1 had the specific tensile strength value up to about 0.2 N/tex, the specific modulus up to about 15 N/tex, and a strain up to about 4%, and showed characteristics of gradual destruction of fibers.

The oxygen functional group-containing carbon nanotube fiber (F-CNTF) produced according to Example 1 had the specific tensile strength value up to about 0.6 N/tex, the specific modulus up to about 90 N/tex, and the strain up to about 1.5%, and then showed characteristics of rapid description.

It was confirmed therefrom that the oxygen functional group-containing carbon nanotube fiber (F-CNTF) produced according to Example 1 showed mechanical performance better in both specific tensile stress and specific modulus than Comparative Example 1.

### Evaluation Example 9: Electrical Conductivity and Tensile Strength Analysis

Tensile stress (N) of the oxygen functional group-containing carbon nanotube fiber (F-CNTF) was measured using FAVIMAT+(short fiber physical property measuring instrument), and the resistance (0) was measured using 4-PROBE method.

The specific tensile strength was measured by dividing tensile stress by linear density (tex) of fiber, and the specific electrical conductivity was measured by a method of measurement length/(resistance*linear density).

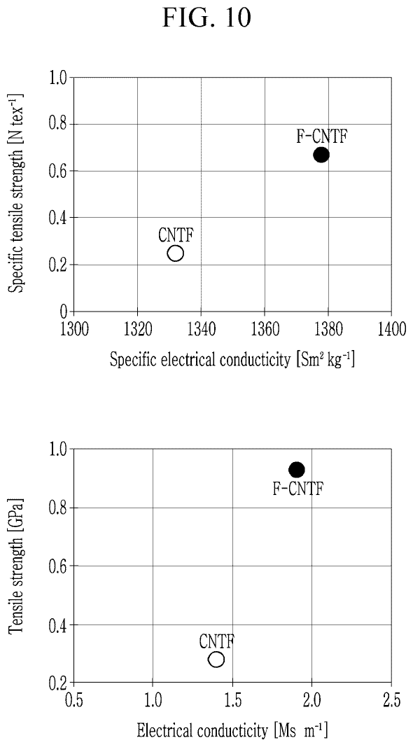

The analysis results are shown in FIG. 10.

Referring to (a) of FIG. 10, it was confirmed that the oxygen functional group-containing carbon nanotube fiber (F-CNTF) produced according to Comparative Example 1 had the specific electrical conductivity of about 1320 Sm²/kg and the specific tensile strength of about 0.2 N/tex.

In addition, it was confirmed that the oxygen functional group-containing carbon nanotube fiber (F-CNTF) produced according to Example 1 had the specific electrical conductivity of about 1380 Sm²/kg and the specific tensile strength of about 0.6 N/tex.

Referring to (b) of FIG. 10, it was confirmed that the carbon nanotube fiber (CNTF) produced according to Comparative Example 1 had an electrical conductivity of about 1.2 MS/m and a tensile strength of about 0.4 GPa.

In addition, it was confirmed that the oxygen functional group-containing carbon nanotube fiber (F-CNTF) produced according to Example 1 had the electrical conductivity of about 2.0 MS/m and the tensile strength of about 1.0 GPa.

It was confirmed therefrom that the electrical properties and mechanical strength of the oxygen functional group-containing carbon nanotube fiber (F-CNTF) produced according to Example 1 were better than those of the carbon nanotube fiber (CNTF) of Comparative Example 1.

### (Electrochemical Performance Evaluation 1: 3-Electrode Electrochemical Activity Test)

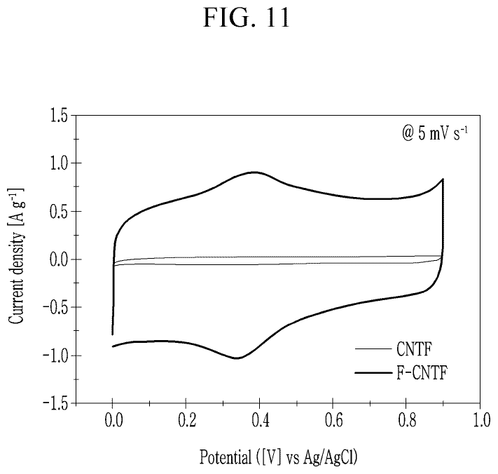

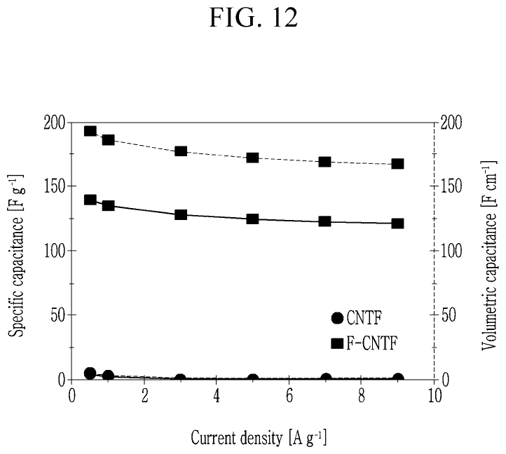

Capacity (F/g) was measured based on cyclic voltammetry (CV) and galvanostatic charge-discharge (GCD), using a 1 M sulfuric acid as an electrolyte, a Pt electrode as a counter, an Ag/AgCl electrode as a reference electrode, and the carbon nanotube fibers produced in Comparative Example 1 and Example 1 as a working electrode, and the results are shown in FIGS. 11 and 12.

Referring to FIG. 11, it was confirmed from the CV graph that the F-CNT fibers had a much larger area than the CNT fibers, which means that the electrochemical activity was improved. In addition, a peak was observed near 0.35 V, which was a peak by an oxygen functional group.

Referring to FIG. 12, it was shown from the results measured in GCD that the capacity value of CNT fibers at a charge-discharge rate of 0.5 A/g was 4.2 F/g, while the capacity value of F-CNT fibers was about 140 F/g, and thus, energy was able to be stored 33 times or more.

### (Electrochemical Performance Evaluation 2: 2-Electrode Electrochemical Activity Test)

In order to produce a real device, a symmetrical supercapacitor cell using the oxygen functional group-containing carbon nanotube fibers (F-CNTF) as both positive electrode/negative electrode was assembled. A PVA/sulfuric acid polymer electrolyte was used as an electrolyte.

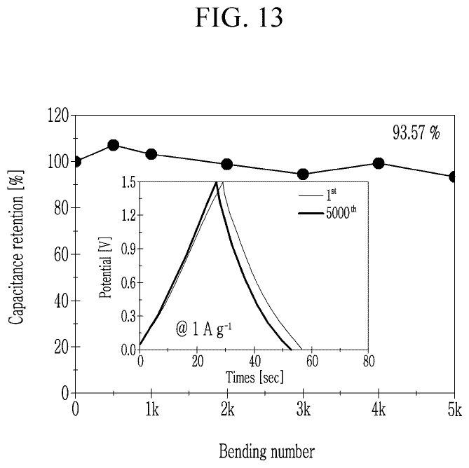

The produced F-CNTF-based fiber-type supercapacitors (FSSCs) were bent 5000 times or more, and then the results of performing the charging and discharging test are shown in FIG. 13.

Referring to FIG. 13, it was confirmed that the discharge capacity depending on the number of bends maintained about 94% of the initial capacity value. It was found that the inset diagram of FIG. 13 is first and 5000th CD graph comparison, and a difference in the values was not large.

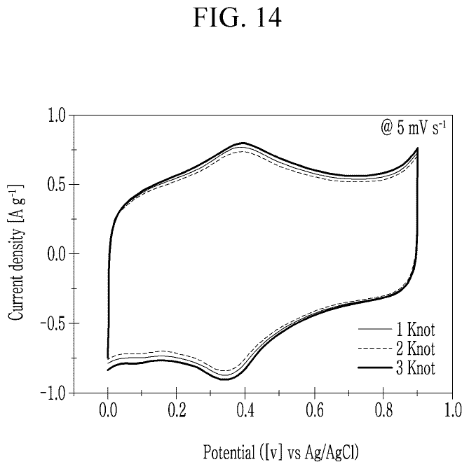

The fiber-type supercapacitor was knotted and the change in the capacity value was measured by CV, and the results are shown in FIG. 14.

Referring to FIG. 14, almost no change in the capacity value was observed even with 3 knots.

### (Electrochemical Performance Evaluation 3: Fiber-Type Supercapacitor (FSSCs) Demonstration)

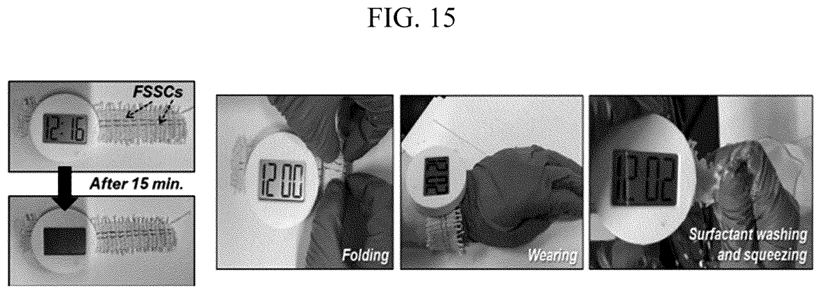

Two lines of F-CNTF-based fiber-type supercapacitor (black) were woven on a plain fiber (white). (see FIG. 15)

After rapid charge of less than 1 minute, it was confirmed that a digital clock was able to be operated for about 15 minutes and the digital clock was able to be operated even after folding, wearing, and washing with a detergent, which shows that it was appropriate as an energy storage device of a wearable device.

Through the above, the preferred exemplary embodiments of the present disclosure have been described, but the present disclosure is not limited thereto, and may be carried out in various variations within the scopes of the claims, the detailed description of the disclosure, and the attached drawing, and this also belongs to the scope of the present disclosure, of course.

Accordingly, the substantial scope of right of the present disclosure may be defined by the attached claims and their equivalents.

1. An oxygen functional group-containing carbon nanotube fiber comprising:
a functionalized carbon nanotube including an oxygen functional group positioned on a surface of a carbon nanotube,
wherein an oxygen content is 8.0 to 20.0 at %.

2. The oxygen functional group-containing carbon nanotube fiber claim 1, wherein:
the oxygen functional group includes one or more selected from —O—C═O, —C—O, —C═O, —C═O—C, and a carboxyl group.

3. The oxygen functional group-containing carbon nanotube fiber of claim 1, wherein:
the oxygen functional group-containing carbon nanotube fiber has a specific tensile strength of 0.3 N/tex or more.

4. The oxygen functional group-containing carbon nanotube fiber of claim 1, wherein:
the oxygen functional group-containing carbon nanotube fiber has a specific electrical conductivity of 1380 Sm²/kg or more.

5. The oxygen functional group-containing carbon nanotube fiber of claim 1, wherein:
the oxygen functional group-containing carbon nanotube fiber has a capacitance (specific capacitance) of 100 F/g or more.

6. A method for producing oxygen functional group-containing carbon nanotube fibers, the method comprising:
forming a spinning dope obtained by dispersing functionalized carbon nanotubes including an oxygen functional group positioned on a surface of a carbon nanotube in a solvent; and
spinning the spinning dope to obtain oxygen functional group-containing carbon nanotube fibers,
wherein the functionalized carbon nanotubes have an oxygen content of 8.0 to 20.0 at %.

7. The method for producing oxygen functional group-containing carbon nanotube fibers of claim 6, wherein:
the functionalized carbon nanotube has a contact angle of 30.0° of less.

8. The method for producing oxygen functional group-containing carbon nanotube fibers of claim 6, wherein:
the functionalized carbon nanotubes include a surface defect structure, and
include one or more surface defect structures per 10 nm of a carbon nanotube length.

9. The method for producing oxygen functional group-containing carbon nanotube fibers of claim 6, wherein:
the functionalized carbon nanotubes are formed by adding a carbon nanotube raw material to an acid solution and then performing an acid treatment.

10. The method for producing oxygen functional group-containing carbon nanotube fibers of claim 9, wherein:
a water contact angle of the functionalized carbon nanotube (F-CNT) is decreased by 60% or more as compared with the contact angle of the carbon nanotube (CNT) raw material.

11. The method for producing oxygen functional group-containing carbon nanotube fibers of claim 6, wherein:
in the forming of a spinning dope obtained by dispersing functionalized carbon nanotubes in a solvent,
a concentration of the functionalized carbon nanotubes in the spinning dope is 50 mg/mL or more.

12. An electrochemical device comprising the oxygen functional group-containing carbon nanotube fiber of claim 1 as an electrode.
